(19) United States
(12) Patent Application Publication
(10) Pub. No.: US 2003/0002729 A1
(43) Pub. Date: Jan. 2, 2003

(54) System for processing overlapping data

(76) Inventor: Craig M. Wittenbrink, Redwood City, CA (US)

Correspondence Address: HEWLETT-PACKARD COMPANY, Intellectual Property Administration, P.O. Box 272400, Fort Collins, CO, 80527-2400, US

(21) Appl. No.: 09/881,424

(22) Filed: Jun. 14, 2001

(51) Int. Cl. G06K 9/00

(52) U.S. Cl. 382/154

(57) ABSTRACT

This disclosure provides a rendering device that blends overlapping fragments via a hardware ordering of those fragments. The preferred device uses a fragment buffer, two depth storages and a frame buffer. In back-to-front rendering, any closest opaque or furthest transparent data is found and stored on the frame buffer. Then, one depth storage is used to hold the depth of next furthest transparent data. In a subsequent pass, the held depth is used to retrieve and process a fragment from the fragment buffer while the second depth storage is simultaneously used to identify the next furthest depth for other fragments. Usage of the depth storages is then switched in each subsequent pass. This disclosure also provides implementations compatible with front-to-back composition, antialiasing, deferred shading and pipeline architecture.

The present invention relates to the processing of overlapping data. More particularly, the present invention relates to the processing of data representing a three dimensional visual environment.

### BACKGROUND

One important task of computers is the generation of data, often, image data representing a three-dimensional environment. For example, games and design applications may permit a user to seemingly navigate through a virtual three-dimensional environment. In these applications, an image database typically includes a compressed description of the overall environment and each significant object appearing in the environment; a computer is used to define a viewpoint within the environment, and to piece together a variable two-dimensional view representing the desired perspective of the viewer. Another important example includes manipulation of physical (i.e., non-virtual) three-dimensional data; for example medical applications such as magnetic resonance image (“MRI”) may store “voxels” of data in either compressed or uncompressed format. In these applications also, a computer can be used to slice away part of the three-dimensional environment and provide any desired view from a perspective inside or outside the confines of the environment. Computers can also, as is conventionally known, perform a variety of special effects such as special shading and texturing, virtual light source movement, and other special effects. The generation of a meaningful display image from stored data is often referred to as “rendering.”

One common problem in rendering relates to the blending of different data along a desired viewing direction; since imaging applications typically permit a user to vary the desired viewing location and perspective (individually and collective, “perspective”), computer hardware and software will typically be required to determine which data in the data set represent objects that are visible, which data represent transparent objects that lie “closer” than other visible data, and which data represent “hidden” objects that are occluded by closer objects for a particular viewing perspective.

Conventionally, there have been at least two well-known approaches to performing these functions, including “Z-buffer architecture” and “A-buffer” or “antialiasing strategies.”

“Z-buffer architecture” usually refers to a hardware architecture where, for each image element, primitive or other object in an image, all data are retrieved as available and blended with existing data in a frame buffer. The way in which the new data are combined typically depends upon associated “Z” or depth values relative to any data already in the frame buffer. If new data represent an opaque object that is relatively “closer” to the desired viewing perspective, the old data is determined to represent a “hidden” object and the new data overwrites the old data in a frame buffer. If new, closer data represents a transparent object, the new data are combined with data already in the frame buffer to yield a blended image. On the other hand, if the new data correspond to a “hidden” object that lies behind any existing data already in the frame buffer for the pixel, the new data is discarded if the existing data is opaque and otherwise it is blended with the existing data.

“Z-buffer” architectures may have problems in correctly computing transparency, in that Z-buffer architectures typically do not first sort data in terms of depth and instead blend data representing overlapping objects in the order received. This problem is especially noticed when dealing with colors. For example, if one imagines a transparent red object on the bottom of a swimming pool viewed from outside the swimming pool, the “true transparency” effect of such a view is that the red object would be tinted blue, since water tends to filter out red color. With many Z-buffer architectures, however, these two images (the object and the transparent water) might be blended in the order received and if the red object was received later in time, these conventional Z-buffer approaches might effectively tint part of the swimming pool red instead of tinting the red object blue as a true underwater object would appear. While most Z-buffer architectures are generally useful for their intended purposes, this “true transparency” problem has inhibited realistic graphics effects in the applications mentioned above. It should also be noted that Z-buffer architectures typically do not support deferred shading, texturing, light source variation and other deferred special effects (these effects must typically be performed beforehand if a Z-buffer architecture is used, with the result that if there are opaque objects in the desired view that obscure other data, quite a bit of processing may be wasted in processing relatively further data that will invariably be discarded).

“A-buffer” or “antialiasing” processes are typically performed in software and utilize complex sub-pixel masks to provide antialiasing. A-buffer processes typically approach each overlapping object as either covering a pixel completely or having a boundary that falls upon a pixel. Since some objects can be opaque and are difficult to blend if computation is performed back-to-front (i.e., in order of decreasing depth), all objects are typically in a first stage of processing sorted in software from front-to-back. Then, data are typically combined beginning with the closest objects. For example, if one imagines three overlapping objects for a particular pixel, e.g., a closest, opaque object that covers the vertical left-half of a pixel, a second transparent object that covers the horizontal top-half of the same pixel, and a furthest, opaque object that covers the vertical right-half of the pixel, A-buffer processing would typically first blend the first objects with “things behind” using mathematical formulas; these formulas would provide contributions representing (a) the opaque object as covering half the pixel, and (b) a mask for later contribution of objects that are not obscured by the first object. In a second iteration, pixel data would be improved using the already-computed data and factoring in a contribution for un-occluded data for the second object using similar formulas, e.g., providing blended data for the first object and part of the second object not obscured by the first, plus a mask for use in later blending of other objects behind the first two. In a final iteration, the mask would be used to impart transparency effects to the third object and to derive a contribution provided by the third object to the overall blend.

A-buffer techniques typically provide good transparency calculation as well as antialiasing protection, and they also can support deferred shading and effects. Unfortunately, A-buffer techniques typically must be performed in software, and require that software to first perform a sort of all overlapping images. These operations are time consuming for a graphics system; for example, since this type is often performed for a million pixels or more per image frame, at twenty-four frames per second, A-buffer techniques may be computationally very expensive and practically speaking, difficult to implement in some real-time applications.

A need exists for a data processing architecture that facilitates transparency handling, preferably without requiring excessive computational resources. More particularly, a need exists for a system that can perform hardware level sorting of image objects (pixels or primitives) that will be used in computing an output image; ideally, such a system would also permit detection and culling (i.e., deletion) of objects that will be obscured in a final output image, such that valuable processing time is not wasted imparting shading and effects to images that will ultimately be discarded. Finally, such a system should preferably be compatible with existing processing techniques (e.g., Z-buffer architecture and A-buffer techniques) in order to permit maximum flexibility in processing three-dimensional environments. The present invention solves these needs and provides further, related advantages.

### SUMMARY

The present invention solves the aforementioned needs by providing a device, method and improvements to process overlapping data. More particularly, the present invention calls for use of a fragment buffer and at least one Z-value storage to provide for quick sorting of overlapping pixel data or primitives, such that overlapping data for an image can be quickly processed to provide varying image views of a three-dimensional physical or virtual environment. Preferably implemented primarily as a hardware solution, fragment depth-sorting and culling can be efficiently handled without overburdening software resources; such an embodiment supports many different solutions including back-to-front processing, front-to-back processing, antialiasing, and deferred special effects. Equally as importantly, the present invention facilitates true transparency effects in hardware. As should be apparent, therefore, the present invention should enhance the ability to correctly process overlapping data and provide for realistic image output in real time.

One form of the present invention provides a device that can receive multiple overlapping fragments and output blended image data. The device includes at least a pixel value storage, a fragment buffer that can store overlapping fragments, a Z-value (e.g., depth) storage and processing logic (e.g., hardware, firmware or software). [In the preferred embodiment, the Z-value storage and pixel value storage are together part of a frame buffer.] The processing logic detects either the closest or furthest visible fragment corresponding to a pixel under consideration and places that image data into the pixel value buffer; in back-to-front image composition (as with Z-buffer architecture), the system will pick the fragment representing the furthest visible image object, whereas if it were desired to use A-buffer techniques (e.g., front-to-back image composition), the system would pick the fragment representing the closest visible image object. The system then finds the fragment for the next furthest (in the case of back-to-front processing) object and moves data for that fragment to combine it with preexisting data in the pixel value buffer. The system then repeats the detecting and processing of fragments until no more data remains in the fragment buffer (at least not for the particular pixel under consideration).

Another form of the invention provides hardware means for identifying and storing in a pixel value buffer a fragment for any closest opaque object or furthest transparent object if there is no closest opaque object, and hardware means for successively detecting and blending into the pixel value buffer in order of greatest depth each fragment representing a remaining furthest unprocessed visible transparent object.

Other forms of the invention provide a method and an improvement, respectively, in the processing of overlapping images.

The invention may be better understood by referring to the following detailed description, which should be read in conjunction with the accompanying drawings. The detailed description of a particular preferred embodiment, set out below to enable one to build and use one particular implementation of the invention, is not intended to limit the enumerated claims, but to serve as a particular example thereof.

### BRIEF DESCRIPTION OF THE DRAWINGS

FIG. 1 is an illustrative diagram of preferred hardware, implementing principles of the invention in a preferred rendering application. In particular, FIG. 1 indicates that the preferred hardware is used during a fragment processing step where multiple fragments are culled or blended as appropriate to develop a two-dimensional image.

FIG. 2 illustrates the preferred hardware of FIG. 1 in somewhat greater detail. In particular, FIG. 2 illustrates the interrelationship between a fragment buffer, fragment logic, and two frame buffers used to process fragments.

FIG. 3 illustrates how the state machine and fragment logic work together to update state information and blend fragments in the preferred embodiment.

FIG. 4 is used to represent preferred processing methodology used by the preferred embodiment; preferably, including three phases of processing.

FIG. 5 illustrates a conceptual relationship between fragments representing hypothetical overlapping image data and a desired viewpoint. The desired viewpoint is represented by a human eye depiction, seen at the left side of FIG. 5, whereas six surfaces, including opaque (hatched backing) surfaces and transparent (plain line) surfaces are seen at the right side of FIG. 5. The six surfaces are distributed horizontally to represent distribution in three-dimensional space, and they are overlapping in the direction of a desired viewing direction, represented by an arrow adjacent the human eye depiction. The preferred application of the present invention would be to process these six surfaces to blend them, such that only one set of data is needed to generate viewed data along the viewing direction.

FIG. 6 is a flowchart representing processing according to the first phase indicated in FIG. 4.

FIG. 7 is a state transition diagram indicating how state information changes in connection with the processing represented by FIG. 6.

FIG. 8 is a flowchart representing processing according to the second phase indicated in FIG. 4.

FIG. 9 is a state transition diagram indicating how state information changes in connection with the processing represented by FIG. 8.

FIG. 10 is a flowchart representing processing according to the third phase indicated in FIG. 4.

FIG. 11 is a diagram used to explain the transition between the phases of processing represented by FIG. 4 and to explain the preferred operation of using at least two Z-value buffers and of alternating how the buffers are used.

FIG. 12 is a state transition diagram indicating how state information changes in connection with the processing represented by FIG. 10.

FIG. 13 is an illustrative diagram similar to FIG. 1, except FIG. 13 shows application of preferred hardware to a deferred shading application (or to lighting, texturing or other forms of deferred effects).

FIG. 14 is a diagram similar to FIG. 11, but is used to explain the transition between the phases of processing used in connection with deferred effects.

FIG. 15 is an illustrative diagram similar to FIG. 1, except FIG. 15 shows application of preferred hardware to an antialiasing application.

FIG. 16 is a block diagram that illustrates processing during the first phase 301 of FIG. 15.

FIG. 17 is a block diagram that illustrates processing during the second phase 303 of FIG. 15.

FIG. 18 is a block diagram that illustrates processing during the third phase 305 of FIG. 15.

FIG. 19 provides a hypothetical set of four surfaces that are to be combined into a single blended fragment or data set.

FIG. 20 is a diagram used to explain the calculation of masks and blending together of the four hypothetical surfaces of FIG. 19.

FIG. 21 illustrates a pipelined hardware approach to antialiasing, which is preferably used in applying antialiasing methodology.

### DETAILED DESCRIPTION

The invention summarized above and defined by the enumerated claims may be better understood by referring to the following detailed description, which should be read in conjunction with the accompanying drawings. This detailed description of a particular preferred embodiment, set out below to enable one to build and use one particular implementation of the invention, is not intended to limit the enumerated claims, but to serve as a particular example thereof. The particular example set out below is the preferred specific implementation of a system that provides for processing of overlapping data, namely, one which does so through the use of hardware level ordering of fragments. The invention, however, may also be applied to other types of systems as well.

I. Introduction To The Principal Parts

The preferred embodiments include hardware that is specially adapted for rendering. More particularly, a first, preferred embodiment described below relates to use of that hardware to perform, similar to methodology used with conventional Z-buffer architecture, assembly of an image from back-to-front that is, beginning furthest away from a desired viewing perspective and continuing until all overlapping objects including those closest to the desired viewing perspective, are combined into blended data. A second embodiment that supports deferred shading using this hardware will also be described further below. Finally, a third embodiment that supports antialiasing or A-buffer techniques using the preferred hardware will be described below.

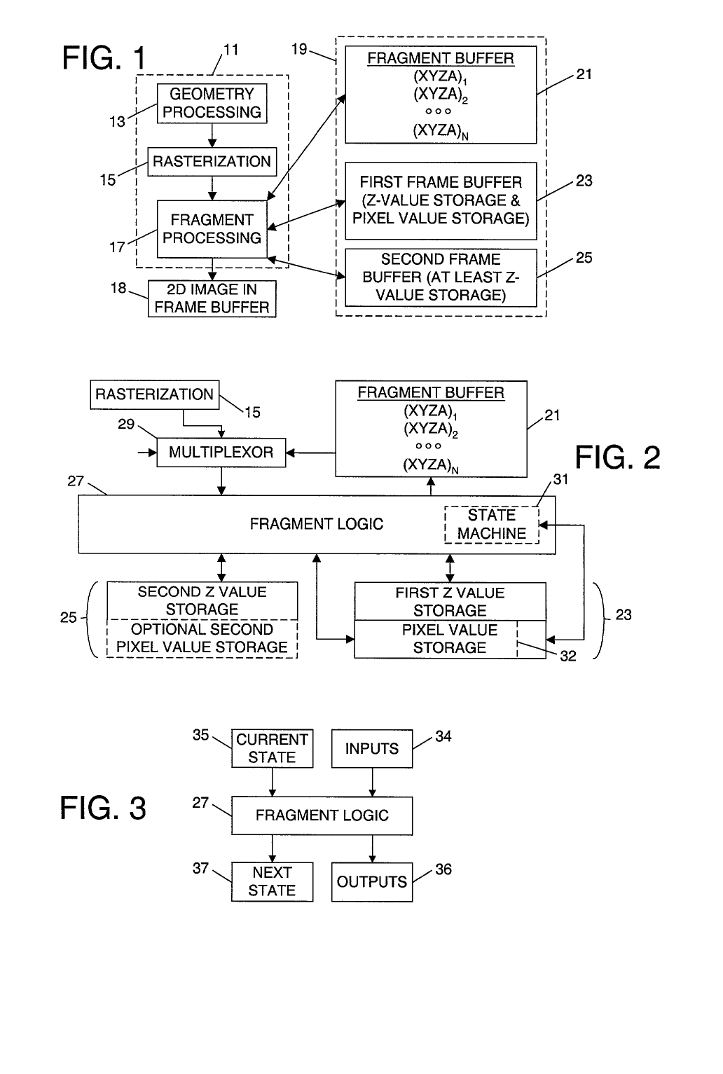

FIG. 1 is used to explain basic operation of this hardware. In particular, a left side 11 of FIG. 1 shows steps that might be conventionally used in taking a data set representing three-dimensional (3D) objects and processing that data set to arrive at a two-dimensional (2D) image that can be displayed to a user. Three process blocks are seen at the left side of FIG. 1, including blocks associated with geometry processing 13, rasterization 15, and fragment processing 17. If a 3D data set is stored in a compressed format, e.g., where objects might be represented by triangle or polygon vertices, then geometry processing 13 is conventionally employed to build objects that might be seen in any desired image and to give those objects a place in the overall 3D data set. Geometry processing is typically also used to define a desired viewpoint, e.g., a perspective used to build a 2D computer image taken from a particular direction within or toward the 3D data set. Rasterization 15 is used to convert primitives (e.g., object representations) into pixel or subpixel data. The result of rasterization will be image data having X, Y and Z (depth) values for each data point relative to the desired viewing perspective. Typically, multiple objects will be processed in rasterization including objects that overlap with each other, e.g., objects that are relatively closer to the desired viewing perspective and objects that are relatively further from the desired viewing perspective and that may be obscured by a relatively closer object. Fragment processing 17 is used according to the principles of the present invention to resolve overlapping primitive or pixel data for a particular X and Y pixel location, such that only a single blended fragment is used for that X and Y location in the two-dimensional image 18 presented to a viewer.

A right side 19 of FIG. 1 shows hardware that is preferably used to assist fragment processing. In particular, this preferred hardware includes a fragment buffer 21, a first frame buffer 23, and a second frame buffer 25. Each frame buffer has at least one storage location for every pixel of the generated 2D image; the first frame buffer 23 has storage space that is sufficient to store at least a Z-value and color, attributes and state information for each pixel location, whereas the second frame buffer has storage space that is sufficient to store at least a Z-value for each pixel. [In an embodiment where antialiasing or some types of special effects are performed the second frame buffer may also be used to process pixel values and, therefore, to support multiple architectures the preferred hardware therefore uses two identical frame buffers. However, in the back-to-front processing scheme described below, special effects and antialiasing are not implemented and part of the storage capacity of the second frame buffer will remain unused.]

Use of this hardware in the preferred embodiment will be further described below in connection with FIG. 2. Importantly, the preferred hardware will typically be embodied in an application specific integrated circuit (“ASIC”) or otherwise as part of a graphics accelerator card that may be either sold with or retrofitted to a personal computer or other data processing system. The steps of rasterization and geometry processing (if appropriate) will typically be implemented via either hardware control (“hardware”) although these steps may also be implemented via firmware or software (collectively, “software”).

FIG. 2 provides additional detail on how the preferred hardware is used to perform fragment logic processing. In particular, individual fragments are obtained from the rasterization step and are input to fragment logic 27 via a multiplexor 29. For each fragment, the fragment logic 27 interrogates the first frame buffer 23 to obtain state information for the X and Y location associated with that fragment and provides that information to a state machine 31 sub-block of the fragment logic. Importantly, the preferred embodiment operates upon fragments that are pixels, where each fragment has an X, Y, Z (coordinate) and “A” (attribute) values; the fragment buffer 21 and fragment logic 27 could also operate upon fragments that are primitives (e.g., polygons) instead of pixels within the spirit of the present invention, but this operation has not been implemented in the preferred embodiment.

If the state information for a particular pixel's X and Y location indicates that a newly-received fragment is the first data received for that X and Y location for the current frame, then the fragment logic 27 stores that fragment in the first frame buffer 23 in a pixel value storage 32 associated with the fragment's X and Y value. Alternatively, if the state information retrieved by the fragment logic 27 indicates that another fragment is already in the pixel value storage 32, then the hardware depicted by FIG. 2 will be used to initially assign incoming fragments to either the first frame buffer 23 or to the fragment buffer 21. Typically, the fragment logic 27 will examine both state information and depth of the existing fragment in the fragment buffer, as well as a Z-value (or depth) of the newly arriving fragment. In back-to-front processing, the greater depth fragment will typically be put on the frame buffer, whereas in front-to-back processing, the relatively closer fragment is assigned to the frame buffer. Typically, any fragment not put on the frame buffer will be queued in the fragment buffer, and processing continues in this manner until all fragments have been received from rasterization.

In fact, the level of processing that occurs during this first, fragment input phase of processing, is dependent upon the processing methodology employed. In back-to-front processing, if state information and depth for the corresponding pixel indicate that the first frame buffer 23 already holds an opaque fragment that is relatively closer to the desired viewing perspective from the new fragment, then the new fragment is simply discarded; since in antialiasing applications an opaque fragment may only partly obscure farther objects, all fragments are retained for front-to-back processing in one buffer or another (unless the masks associated with the particular pixel location indicate complete opacity, and that certain fragments may be discarded). Further information about precise treatment of newly-received fragments will be provided in connection with the embodiments discussed below.

Irrespective of processing methodology, in the preferred embodiment, the fragment buffer 21 is a large first-in first-out (“FIFO”) buffer holding pixel attributes “A,” together with the X, Y and Z values for all points on the desired viewing image. This buffer is essentially a circular buffer, with control registers maintained by the fragment logic to define buffer start, buffer end, and to determine at various stages of processing whether there are any fragments on the fragment buffer. The fragment buffer can be any desired size depending upon the hardware implementation, and preferably, software provides support in case of buffer overflow for writing a least recent “page” of fragments to off-board memory and for retrieving and exchanging such “pages” as appropriate during processing.

FIG. 3 provides yet another illustration used to help explain operation of the preferred embodiment. In particular, the fragment logic 27 receives fragments as inputs 34 and, in dependence upon each fragment's XY (pixel) coverage, retrieves existing state information for each associated pixel. The fragment logic uses this information to provide outputs 36 (e.g., sorting information, blended fragments, etc.) as well as updated state information 37 that is stored back into the frame buffer in association with the pertinent pixel.

II. Use Of The Preferred Hardware In Back-To-Front Processing

A. Introduction To Back-To-Front Processing Phases

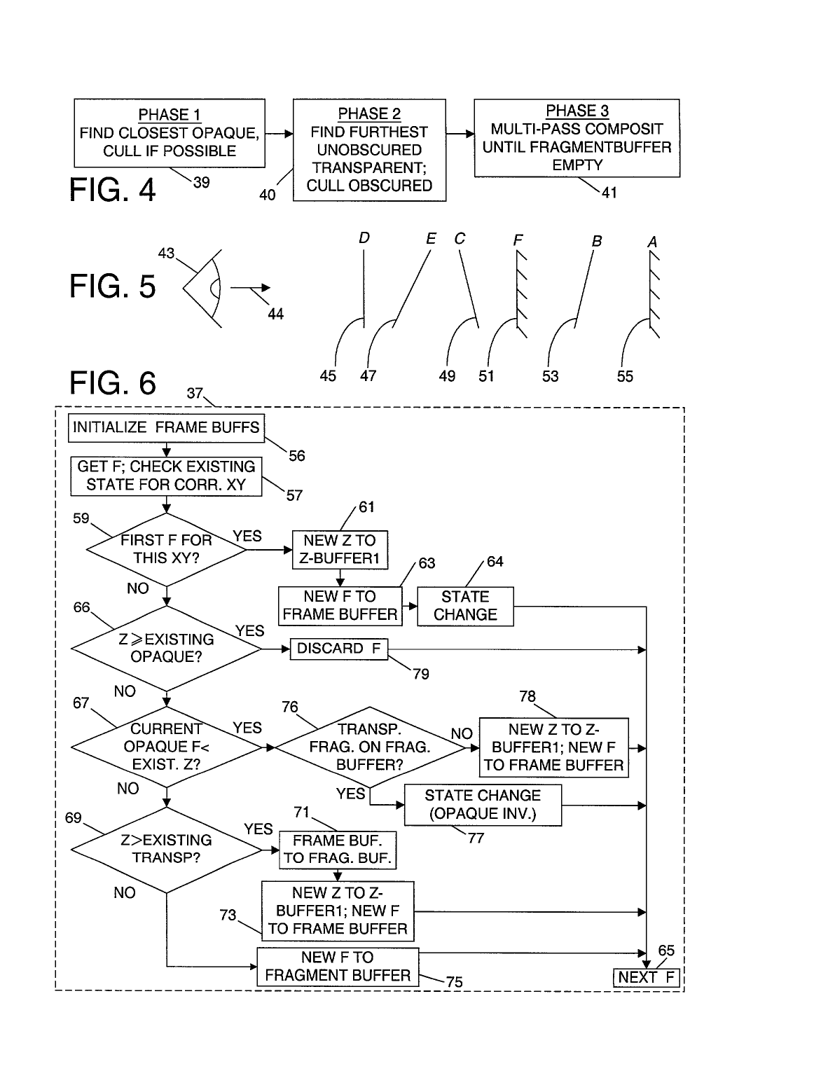

Use of the preferred hardware to perform back-to-front processing will now be described in connection with FIGS. 4-12. In particular, processing is preferably performed in up to three phases, 39, 40 and 41, as indicated in FIG. 4. During all phases, the fragment logic will identify from the memory control registers referred to above whether there are any fragments on the fragment buffer and, accordingly, whether processing has been completed.

The first phase 39, relating to receipt of fragments from rasterization (or from a voxel set, for example), was introduced briefly above. In this phase, the device will initially assign incoming fragments to the frame buffer or fragment buffer as appropriate, and cull (discard) obscured fragments if possible. In typical back-to-front processing applications, partial pixel opacity (e.g., a pixel that is half-opaque and half-translucent) cannot occur, and opacity will be easily recognizable directly from an incoming fragment's values. In antialiasing applications, several masks will be computed during processing and if the appropriate mask indicates complete opacity, then fragments providing hidden information may be detected and culled during phase one. During phase one in the preferred back-to-front processing methodology, the fragment logic will simultaneously use the (first) frame buffer 23 and to store any closest opaque fragment for the X, Y pixel location consideration or, if there is no closest opaque fragment, the furthest transparent fragment. The fragment logic stores the Z-value of any identified fragment into the Z-value storage of the first frame buffer and also updates state information for the corresponding pixel for quick use in analyzing and processing new fragments as they arrive.

During a second phase of processing 40, the system will begin processing “excess” (i.e., possibly overlapping) fragments which have been stored in the fragment buffer 21. To perform this processing, the fragment logic 27 for each fragment on the fragment buffer analyzes state information for the corresponding pixel location, and attempts to (a) cull the fragment if obscured as indicated by an “OPAQUE_INVALIDATE” state (b) blend (composite) the furthest transparent fragment with frame buffer contents for other states, and (c) identify the furthest remaining transparent fragment and store the corresponding depth (Z) value in the Z-value storage (for processing and composition during the next phase).

Once the second phase is complete, the fragment logic will enter a third phase of processing 41 which is similar to second phase processing, except that there should be no fragments remaining in the fragment buffer which need to be culled. During this phase, the fragment logic will for each fragment attempt to blend that fragment into the frame buffer via what is effectively hardware ordering of the fragments (preferably in back-to-front order). For these purposes, it will be recalled that the fragment buffer is preferably a FIFO memory, and hardware preferably maintains in dedicated registers a pointer to the beginning and end of this memory. As each fragment is processed in the preferred embodiment, the Z-value storage for the corresponding pixel location will contain an indicia of whether the fragment is the furthest remaining fragment on the fragment buffer for the pixel location; if the fragment is not the furthest visible fragment, it is re-queued into the fragment buffer (as though it were a newly-received fragment). The fragment logic will cycle through the fragment buffer (essentially in circular fashion) as necessary to blend all remaining fragments until none are left in the fragment buffer; the processing and image frame are “done” when the fragment buffer is empty.

It will also be recalled that the preferred hardware uses two Z-value storages. During the third phase (and the second phase as well, except for pixel locations having the “OPAQUE_INVALIDATE” state), the fragment logic preferably uses one of these Z-value storages as storage for the previously computed index (i.e., depth of furthest visible fragment) to match and remove that fragment from the fragment buffer; simultaneously, it uses the other Z-value storage (of the other frame buffer) to identify and isolate a subsequent “furthest fragment” for processing in the next iteration. Each time the fragment logic finishes passing through the earlier bounds of the fragment buffer, the fragment logic toggles the Z-value storages for this purpose. Thus, with each iteration through the fragment buffer for a X, Y location, the third phase will alternate in this manner, using the Z-value storages of the first and second frame buffers in alternating fashion to effectively sort fragments according to Z-values and to composite those fragments one at a time with the image data already in the first frame buffer. These iterations are respectively referred to further below as “odd” and “even” phases of processing.

Once the third phase is complete, the first frame buffer will (in the preferred embodiment) contain blended image data for each image point in the final output image.

B. Additional Detail On The Use Of Three Phases; Discussion Of Hypothetical Six Surface Overlap

Notably, in each phase of the preferred-embodiment-processing just described, in the event that two fragments have exactly the same Z-value, an existing Z-value that has already been stored in a frame buffer is regarded as being farther from the desired viewing perspective than the new fragment and, consequently, a subsequent similar-depth fragment is left in the fragment buffer for subsequent processing as if it were a relatively-closer fragment.

FIG. 5 is a diagram used to explain the sorting and compositing of fragments using the operation and hardware just described, using a hypothetical example of six surfaces. A discussion of this example will be intertwined in the discussion below with a description of logic flow and use of general state information during each phase of processing. Importantly, attached flow diagrams for each phase of processing indicate general state and state transition information for ease of explanation; specific state transition information used in the preferred embodiment is illustrated in three tables set forth below.

A left side of FIG. 5 shows a depiction 43 of a human eye, with an arrow 44 adjacent that depiction indicating a desired viewing perspective. To the right of that depiction, six surfaces 45, 47, 49, 51, 53 and 55 corresponding to a number of object surfaces in the 3D data set. Opaque surfaces are depicted in FIG. 5 by hatched backing lines, whereas transparent surfaces do not have such backing. The various surfaces of FIG. 5 could represent a front and back surface for each object, although for ease of explanation it should be assumed that each surface stands on its own. As indicated in FIG. 5, a first 45, a second 47 and a third surface 49 in order of increasing distance from the viewer's perspective are transparent. However, the fourth surface 51 is indicated to be opaque. Finally, the fifth surface 53 from the viewer's perspective is transparent, whereas the six, most distant surface 55 is opaque. From the desired viewing perspective, an observer in this hypothetical should see through the first three transparent surfaces 45, 47 and 49, and have further view blocked by the fourth, opaque surface 51; the viewer would not see the fifth surface 53 or the sixth surface 55 which would be completely obscured from view. Also, for purposes of this hypothetical, it should be assumed that the six surfaces of FIG. 5 arrive from a rasterization step or other input in an order represented by the alphanumeric lettering “A”-“F”: that is, the surfaces are received from rasterization in the order of furthest-most surface 55 (sixth in distance, opaque); second furthest surface 53 (fifth in distance, transparent); third-closest surface 49 (transparent); closest surface 45 (transparent); second closest surface 47 (transparent); and the third furthest surface 51 (fourth in distance, opaque). Importantly, in this description the term “closest” or “nearest” surface will refer to image data within a three-dimensional environment that is closest to a desired viewpoint (represented by the human eye depiction 43 in FIG. 5).

These hypothetical surfaces would in the preferred embodiment be processed using the three phases of processing earlier described in connection with FIG. 4. Importantly, the operations of FIG. 4 are performed as appropriate to provide data for all pixels that will be visible in a computer image to be displayed to a human viewer. Before processing begins as represented in FIG. 4, pixel values for a prior image frame would have been unloaded and the state information and two frame buffers reset or, where several frame buffers are used, the pixel value storage of one frame buffer may be unloaded for display while a new image frame is being assembled in a different frame buffer.

In the first phase of processing, fragments are collected as received and placed either into pixel value storage for the appropriate pixel location (i.e., in the frame buffer) or into the fragment buffer as appropriate. In this “phase one,” the system attempts to find any closest opaque fragment and to cull if possible any subsequently-arriving image data that may be hidden by an opaque fragment. Only subsequently-arriving, obscured image data will be culled during this phase, because a later-arriving fragment may under some circumstances obscure fragments already stored in the fragment buffer, and culling of such obscured fragments may have to be left until the second phase of processing. This occurrence will be reflected in the example presented by the six hypothetical surfaces of FIG. 5.

The first-arriving fragment “A” in the hypothetical presented by FIG. 5 corresponds to the most distant surface, 55, which is opaque. State information, which would be initialized as part of frame buffer and Z-value storage initialization 56 at the start of processing for each new frame, reveals that this most distant fragment is the first fragment for the particular pixel under consideration. Accordingly, this fragment is immediately stored in the frame buffer and state information for the particular pixel location is updated by the fragment logic. This processing is represented by function and decision blocks 57, 59, 61, 63, 64 and 65 in FIG. 6.

The second-arriving fragment “B” corresponds to the fifth-most distant surface, 53, and upon arrival, the fragment logic checks existing state information for the pixel location and determines that the new fragment is a relatively closer transparent fragment that is not obscured by any preexisting frame buffer contents. Accordingly, the newly-arriving fragment is immediately sent to the fragment buffer and state information is updated, all as represented by blocks 66, 67, 69, 75 and 65 of FIG. 6. If the newly-arriving fragment had instead been obscured by the opaque fragment already in the frame buffer, the new fragment would have been discarded as indicated by block 79; since such is not the case, the new fragment is queued in the fragment buffer. Also, if the newly-arriving fragment was opaque and closer than earlier received fragments, then the newly-received fragment would be stored on the frame buffer with the “OPAQUE_INVALIDATE” state being set if the fragment buffer holds invalid fragments, all as represented by numerals 76, 77 and 78 of FIG. 6.

Similar processing also occurs during phase one for each of the next three arriving fragments “C,” “D” and “E,” which are all transparent and relatively closer than the opaque fragment in the frame buffer. Accordingly, the fragments corresponding to surfaces 47, 49 and 51 are all also queued in the fragment buffer.

Finally, when the last fragment “F” arrives, corresponding to the fourth-most distant, opaque surface, the fragment logic will determine that this fragment obscures the other opaque fragment “A” already stored in the frame buffer. This fragment “F” also obscures an earlier transparent fragment “B” that was queued in the fragment buffer, but this obscured transparent fragment is left in the fragment buffer and will be culled in phase two. The most distant surface “A” is discarded during phase one, and the latest-arriving fragment (which obscures the most distant fragment) takes its place. Thus, at the end of the first phase of processing, five fragments will be left, one fragment “F” being stored in the frame buffer and the remainder “B,” “C,” “D” and “E” being stored in the fragment buffer. It should be noted here that if the order of arrival had been different, e.g., any later-arriving fragment was both the most distant yet found and there were no opaque fragments yet found, then a visible transparent fragment would have been present in the frame buffer and instead of being discarded, this fragment would be “bumped” into the fragment buffer, as represented by blocks 71 and 73 of FIG. 6. Also, as mentioned if a transparent fragment were instead to arrive later than an earlier-received opaque fragment, then the new transparent fragment would simply be discarded as indicated by block 79. Importantly also, the fragment logic concurrent with this processing also determines the most distant fragment not in the frame buffer but in the fragment buffer for this particular pixel location, and it stores the “Z” or depth value of this fragment in a Z-value storage for the particular pixel. This processing is performed by comparing, each time a fragment goes to the fragment buffer for the particular pixel, the Z-value of the fragment being placed into the fragment buffer with the Z-value storage contents, and by overwriting the Z-value storage contents if less than the Z-value of the current fragment. At the end of phase one processing, the Z-value storage will contain the Z-value of the fifth most distant, transparent surface “B.”

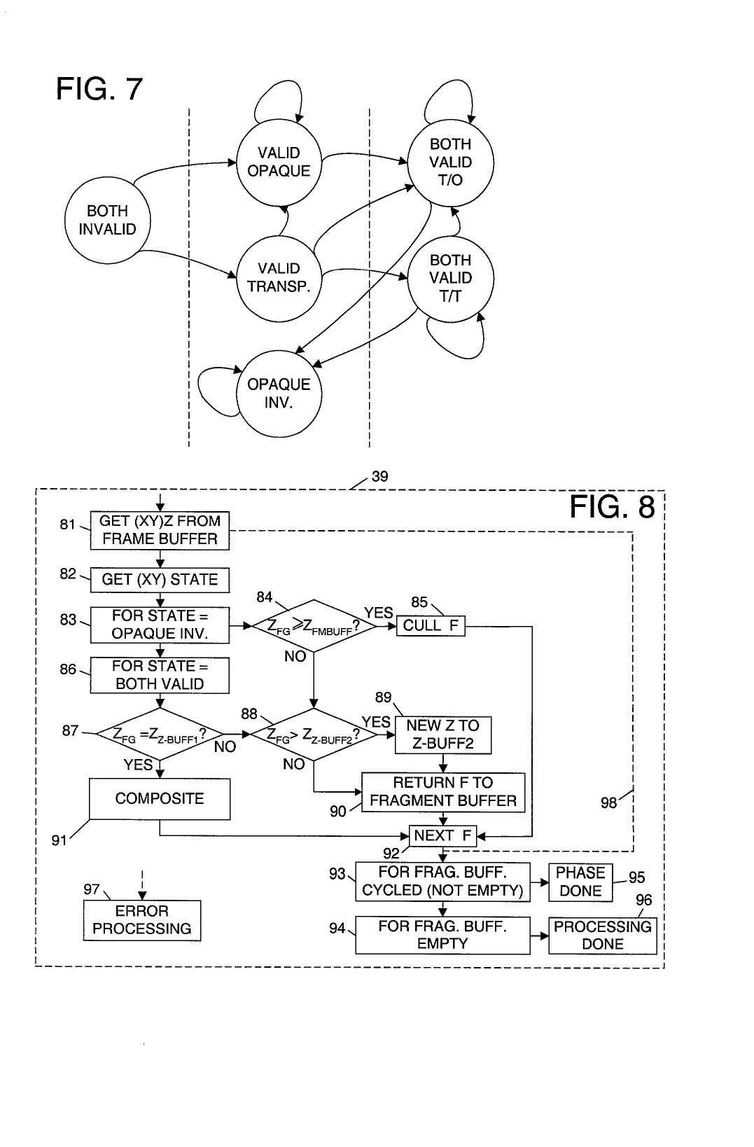

FIG. 7 is a state transition diagram for the processing just described. FIG. 7 shows two vertical dashed lines which divide FIG. 7 into left, middle, and right portions. The left portion of FIG. 7 represents no fragments yet received for a particular X, Y location; “BOTH_INVALID” is the only state used to represent this condition, and at the start of processing for each new frame, the fragment logic will initialize state information for each pixel location to have this state. The middle portion of FIG. 7 represents processing where a new fragment has been received for the X, Y location and at least the frame buffer has been filled with a fragment. Three states are used to represent this condition, including “VALID_OPAQUE,” “VALID_TRANSPARENT,” and “OPAQUE_INVALIDATE.” These three states respectively indicate (a) receipt of one opaque fragment only for the particular X, Y location with no overlapping data in the fragment buffer, (b) receipt of one transparent fragment for the particular X, Y location with no overlapping data in the fragment buffer, and (c) receipt of an opaque fragment that is closer than at least one previous fragments in the fragment buffer, such that there is at least one good fragment (the newly-received opaque fragment), at least one possibly invalid (obscured) fragment in the fragment buffer and possibly zero or some visible prior fragments for this pixel location in the fragment buffer. Finally, the right portion of FIG. 7 represents the occurrence of a new fragment and one or more previous fragments that are valid, such that at least one visible fragment will be in the frame buffer and one or more visible fragments will also be in the fragment buffer for the particular XY location. As seen at the right portion of FIG. 7, there are two states to denote this latter condition, including “BOTH_VALID T/O” and “BOTH_VALID T/T.” These states respectively represent the conditions where (a) the frame buffer stores a relatively further, opaque fragment, and at least one newer, relatively closer transparent fragment has been sent to the fragment buffer, and (b) there are at least two valid transparent fragments, including one stored in the frame buffer and one or more closer fragments stored in the fragment buffer. It will be readily apparent to one having skill in electronics that each of the states described above will be represented in binary fashion, with state or state changes being loaded into a multiple bit register for the particular X, Y location. The frame buffer ideally will have storage for state information for each X, Y location. Specific state and state transition information for phase one processing is identified by Table I, below.

TABLE I
PHASE ONE STATE AND STATE TRANSITION INFO.

| CURRENT STATE | INPUTS | OUTPUTS | NEW STATE |
|---|---|---|---|
| BOTH_INVALID | F_{O} | B = F | VALID OPAQUE |
| BOTH_INVALID | F_{T} | B = F | VALID_TRANS. |
| VALID_OPAQUE | F_{Z} ≧ B_{Z} | CULL F | VALID_OPAQUE |
| VALID_OPAQUE | F_{O}, F_{Z} < | B = F | VALID_OPAQUE |
| | B_{Z} | | |
| VALID_OPAQUE | F_{T}, F_{Z} < | B_{NZ} = F_{Z}, | BOTH_VAL._T/O |
| | B_{Z} | QUEUE F | |
| VALID_TRANS. | F_{O}, F_{Z} ≦ | B = F, | VALID_OPAQUE |
| | B_{Z} | CULL OLDB | |
| VALID_TRANS. | F_{O}, F_{Z} > | QUEUE OLDB, | BOTH_VAL._T/O |
| | B_{Z} | B_{NZ} = B_{Z}, B = F | |
| VALID_TRANS. | F_{T}, F_{Z} ≦ | B_{NZ} = F_{Z}, | BOTH_VAL._T/T |
| | B_{Z} | QUEUE F | |
| VALID_TRANS. | F_{T}, F_{Z} > | QUEUE OLDB, | BOTH_VAL._T/T |
| | B_{Z} | B_{NZ} = B_{Z}, B = F | |
| BOTH_VAL._T/O | F_{X}, F_{Z} ≧ | CULL F | BOTH_VAL._T/O |
| | B_{Z} | | |
| BOTH_VAL._T/O | F_{O}, F_{Z} < | B = F | BOTH_VAL._T/O |
| | B_{Z} & F_{Z} > | | |
| | B_{NZ} | | |
| BOTH_VAL._T/O | F_{O}, F_{Z} < | B = F, B_{NZ} = O | OPAQUE_INV. |
| | B_{Z} & F_{Z} ≦ | | |
| | B_{NZ} | | |
| BOTH_VAL._T/O | F_{T}, F_{Z} < | B_{NZ} = F_{Z}, | BOTH_VAL._T/O |
| | B_{Z} & F_{Z} > | QUEUE F | |
| | B_{NZ} | | |
| BOTH_VAL._T/O | F_{T}, F_{Z} < | QUEUE F | BOTH_VAL._T/O |
| | B_{Z}& F_{Z} ≦ | | |
| | B_{NZ} | | |
| BOTH_VAL._T/T | F_{O}, F_{Z} > | QUEUE OLDB, | BOTH_VAL._T/O |
| | B_{Z} | B_{NZ} = B_{Z}, B = F | |
| BOTH_VAL._T/T | F_{O}, F_{Z} ≦ | B = F | BOTH_VAL._T/O |
| | B_{Z} & F_{Z} > | | |
| | B_{NZ} | | |
| BOTH_VAL._T/T | F_{O}, F_{Z} ≦ | B = F, B_{NZ} = 0 | OPAQUE_INV. |
| | B_{Z} & F_{Z ≦} | | |
| | B_{NZ} | | |
| BOTH_VAL._T/T | F_{T}, F_{Z} > | QUEUE OLDB, | BOTH_VAL._T/T |
| | B_{Z} | B_{NZ} = B_{Z}, B = F | |
| BOTH_VAL._T/T | F_{T}, F_{Z} ≦ | B_{NZ} = F_{Z}, | BOTH_VAL._T/T |
| | B_{Z}& F_{Z} > | QUEUE F | |
| | B_{NZ} | | |
| BOTH_VAL._T/T | F_{T}, F_{Z} ≦ | QUEUE F | BOTH_VAL._T/T |
| | B_{Z} & F_{Z} ≦ | | |
| | B_{NZ} | | |
| OPAQUE_INV. | F_{Z} ≧ B_{Z} | CULL F | OPAQUE_INV. |
| OPAQUE_INV. | F_{O}, F_{Z} < | B = F | OPAQUE_INV. |
| | B_{Z} | | |
| OPAQUE_INV. | F_{T}, F_{Z} < | QUEUE F | OPAQUE_INV. |
| | B_{Z} | | |

[In Table I, above, the designation F refers to the fragment from the fragment buffer, the designation B refers to the contents of the frame buffer, the subscript designation Z refers to associated Z-value, the subscript designations O, T and X respectively refer to opaque, transparent and either opaque or transparent, the subscript designation NZ refers to the contents of a first Z-value storage used for purposes of isolating the next furthest fragment that will be the furthest remaining fragment in the next phase of processing.]

In processing the hypothetical surfaces discussed above in connection with FIG. 5, state information for the pertinent pixel would initially be “BOTH_INVALID.” As a first arriving fragment “A” corresponding to surface 55 is received, state information would be updated to “VALID_OPAQUE” indicating that there is one fragment for this pixel location on the frame buffer and no fragments for this pixel location on the fragment buffer. When the second (transparent) fragment “B” arrives, corresponding to second furthest surface 53, state information would be changed to “BOTH_VALID T/O,” indicating one valid opaque fragment on the frame buffer and at least one transparent fragment on the fragment buffer for the particular pixel location. This state will be maintained through receipt of the next three surfaces, “C”-“E”, with state information and the depth of the frame buffer's fragment being accessed each time and being used to determine that the newly-received fragments are valid and may be stored in the fragment buffer. Finally, when the last surface “F” arrives, the system determines that this fragment invalidates prior fragment(s) on the fragment buffer and that the Z-value storage may need to have its stored value updated to reflect the second furthest visible fragment; the state is therefore changed to “OPAQUE_INVALIDATE.”

FIG. 8 is a block diagram that shows processing during phase two, where any furthest visible fragment for the particular XY location is composited and the next furthest fragment on the fragment buffer is isolated if appropriate (i.e., for pixels having a “BOTH_VALID” state), and where any obscured fragments in the fragment buffer are culled and eliminated for pixels having an “OPAQUE_INVALIDATE” state. As mentioned earlier, fragment processing is finished once the fragment buffer is empty; accordingly, after the processing of each fragment, the system is alerted if all fragments have been processed by coinciding memory control registers (i.e., concurrence in fragment buffer begin and end values), as represented in FIG. 8 by reference numerals 94 and 96.

As each fragment is retrieved, if the corresponding pixel's state information indicated the “OPAQUE_INVALIDATE” state, then the system simply determines whether the current fragment is obscured (by reference to the opaque fragment in the frame buffer). If the fragment is obscured, the system simply culls the fragment from the fragment buffer or returns that fragment to the fragment buffer and updates greatest depth information for the next phase as appropriate, as indicated by blocks 81-85 and 88-90 of FIG. 8. For other states (i.e., for “BOTH_VALID” states) the retrieved fragment is determined to be a visible fragment, and it is composited if the primary Z-value storage indicates that it is the furthest fragment remaining on the fragment buffer, as indicated by blocks 86, 87 and 91 of FIG. 8. At this time of compositing, any detected state of “BOTH_VALID T/T” is automatically converted to a state of “BOTH_VALID T/O.” If the retrieved fragment is not the furthest fragment remaining on the fragment buffer, the Z-value for the retrieved fragment is then compared to the second Z-value storage to determine whether the retrieved fragment is the next-furthest visible fragment (i.e., the closest fragment remaining in the fragment buffer in the next phase of processing), and if appropriate, the Z-value for the retrieved fragment overwrites the contents of the second Z-value storage, as indicated by blocks 88, 89 and 90. Fragments that are neither culled nor composited during second phase processing (i.e., un-obscured and visible fragments) are returned to the fragment buffer for subsequent processing, and loop begins anew with another fragment, as indicated by block 92. At the end of phase two once all fragments in the fragment buffer have been processed and returned to the fragment buffer as appropriate (as indicated by blocks 93 and 95), all obscured fragments will have been culled from the fragment buffer such that only visible fragments remain. In addition, the second Z-value storage for each pixel corresponding to overlapping fragments still in the fragment buffer will hold a Z-value matching the furthest visible fragment in the fragment buffer corresponding to that pixel. Thus, in phase two in the preferred embodiment, hardware is used to effectively sort a fragment according to greatest depth, for use in the next stage of processing. In fact, a true sort does not occur, since fragments still in the fragment buffer are maintained in a FIFO order relative to their original receipt by the fragment logic, but a Z-value has been isolated (and stored in the second Z-value storage) that will be used to isolate and extract the fragment having the greatest depth for that pixel location during the next phase of processing; as a result of this processing, fragments are extracted and blended in the desired order, i.e., in back-to-front order in this example.

Applying this processing to the five hypothetical surfaces of FIG. 5 which remain after phase one processing, the second phase will result in the fragments “D,” “E” and “C” being examined and re-queued in the fragment buffer, whereas fragment “B” would be determined to lie behind the Z-value of the existing fragment in the frame buffer, and therefore culled. Phase two processing would therefore leave four fragments corresponding to the surfaces of FIG. 5, including the opaque fragment “F” (still in the frame buffer) and three transparent fragments “D,” “E” and “C.” Notably, all fragments left represent visible image data that will be blended in phase three. Phase two processing would also write the Z-value for the farthest transparent fragment of the fragment buffer, fragment “C” into the second Z-value storage for the pixel in question.

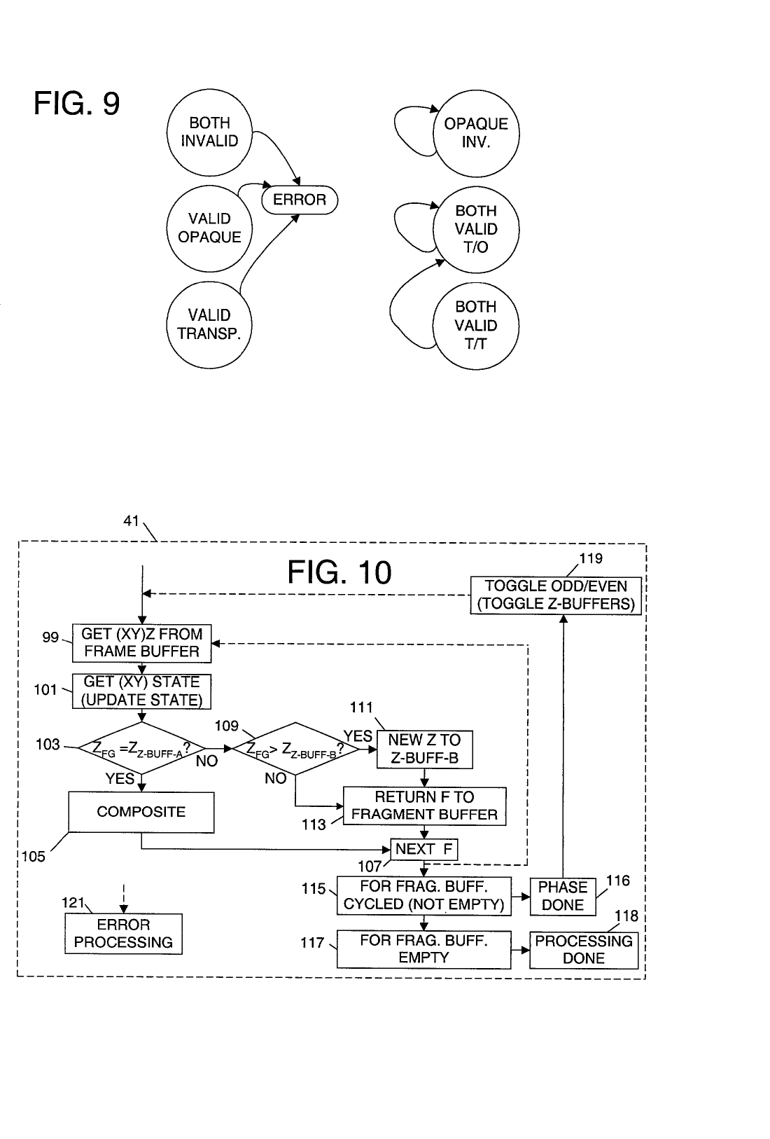

FIG. 9 shows general state transition information associated with the processing of phase two in the preferred back-to-front processing. In particular, during phase two, state information for the pixel location under consideration will be maintained whether or not any obscured fragments are culled from the fragment buffer. As indicated at the left-hand side of FIG. 9, three states “BOTH_INVALID,” “VALID_OPAQUE” and “VALID_TRANSPARENT” should not be seen during phase two, since the fragment buffer should not hold any fragments for those pixels; if any of these states are encountered during comparison of fragment buffer contents with specific pixel locations (and their states), an error is detected and may be handled as appropriate. [Error processing, collectively referred to by reference numeral 97 in the figures, can include any convention mechanisms for error handling, such as producing substitute data for the pixel location via averaging of adjacent pixel data. The error can also be ignored since presumably the error will be limited to a single pixel only; alternatively, aggregate errors for a current frame can be applied to a threshold and used to detect any hardware or software failure, and to trigger a responsive “Windows” error message on a user's computer.] The states “BOTH_VALID T/O” and “BOTH_VALID T/T” are essentially maintained throughout phase two, with a “BOTH_VALID T/T” state being converted to a “BOTH_VALID T/O” state. The state “OPAQUE_INVALIDATE” is also maintained throughout phase two, albeit at the end of phase two processing there will be no more obscured fragments for the pixel location under consideration which remain for processing. Since in connection with the discussion of six hypothetical surfaces of FIG. 5 it will be recalled that phase one left the state “OPAQUE_INVALIDATE” for the pixel under consideration, this state will remain unchanged following phase two processing. Table II below gives specific state and state transition information for phase two processing.

TABLE II
PHASE TWO STATE AND STATE TRANSITION INFO.

| CURRENT | | | |
|---|---|---|---|
| STATE | INPUTS | OUTPUTS | NEW STATE |
| BOTH_VAL._{—} | F_{Z} = B_{NZ} | COMPOSITE | BOTH_VAL._{—} |
| T/O | | | T/O |
| BOTH_VAL._{—} | F_{Z} ≠ B_{NZ}, | B′_{NZ} = F_{Z}, | BOTH_VAL._{—} |
| T/O | B′_{NZ} ≧ B_{NZ} | QUEUE F | T/O |
| BOTH_VAL._{—} | F_{Z} ≠ B_{NZ}, | QUEUE F | BOTH_VAL._{—} |
| T/O | B′_{NZ} < B_{NZ}, | | T/O |
| | F_{Z} ≦ B′_{NZ} | | |
| BOTH_VAL._{—} | F_{Z} ≠ B_{NZ}, | B′_{NZ} = F_{Z}, | BOTH_VAL._{—} |
| T/O | B′_{NZ} < B_{NZ}, | QUEUE F | T/O |
| | F_{Z} > B′_{NZ} | | |
| OPAQUE_INV. | F_{Z} ≧ B_{Z} | CULL F | OPAQUE_INV. |
| OPAQUE_INV. | F_{Z} < B_{Z} & F_{Z>} | B_{NZ} = F_{Z} | OPAQUE_INV. |
| | B_{NZ} | QUEUE F | |
| OPAQUE_INV. | F_{Z} < B_{Z} & F_{Z} ≦ | QUEUE F | OPAQUE_INV. |
| | B_{NZ} | | |

(OPAQUE_INV. provides same behavior as BOTH_VAL._T/O of phase one)

[In Table II, above, the designation F refers to the fragment from the fragment buffer, the designation B refers to the contents of the frame buffer, the subscript designation Z refers to associated Z-value, the subscript designation NZ refers to the contents of the primary Z-value storage used for purposes of compositing, and the designation B′_{NZ} refers to the contents of the secondary Z-value storage used for purposes of isolating the next furthest fragment that will be the furthest remaining fragment in the next phase of processing.]

FIG. 10 is a block diagram used to explain the operation of the preferred hardware during phase three.

As was the case with phase two, processing in phase three will repeatedly query whether the fragment buffer is empty and, consequently, whether processing is done; this query can be implemented either using firmware or using an interrupt triggered upon coincidence of the memory control start and end registers, discussed earlier (this processing is collectively indicated by blocks 117 and 118 in FIG. 10). Since processing in phase two leaves Z-values of furthest transparent fragments in pertinent XY pixel coordinate locations of the Z-value storage, phase three cycles through the fragment buffer to examine each fragment left following phase two. As indicated by blocks 99 and 101, for each fragment, the fragment logic analyzes the corresponding pixel (XY) location of the frame buffer, specifically, the Z-value storage associated with that location, to retrieve the Z-value furthest transparent fragment for that location. Should a match between these two Z-values be detected, the fragment taken from the fragment buffer is immediately composited into the frame buffer, as indicated by blocks 103 and 105 of FIG. 10. If no match is detected, the fragment logic compares the Z-value of the fragment taken from the fragment buffer with the Z-value of the corresponding pixel location in the other frame buffer, as indicated by block 109. If the Z-value of the fragment is greater than contents of this Z-value storage, then the Z-value storage is overwritten with the Z-value of the new fragment, as indicated by block 111; if not, the Z-value storage retains its preexisting contents. The effect of this operation is that when a full cycle has been made through the fragment buffer, the secondary Z-value storage for each pixel location will have either a minimal distance (the initialization value) or a Z-value of the furthest remaining transparent fragment remaining for processing (in the fragment buffer). As indicated by block 113, all fragments not composited into the frame buffer in process step 107 are returned to the fragment buffer. If appropriate (i.e., if a fragment is compared to a pixel having an “OPAQUE_INVALIDATE” state), the state information for the pertinent pixel is updated, as also represented by processing block 101. As was the case during phase two processing, the system checks internal registers to determine whether the fragment buffer has been cycled or is empty, as indicated by blocks 115-118.

In the context of the six surface hypothetical of FIG. 5, it will be recalled that only four fragments remain after phase two. A first cycle through the fragment buffer would effectively blend fragment “C” into the frame buffer, and would load the Z-value of fragment “E” into the secondary Z-value storage for use in subsequent processing; at the end this first cycle, the frame buffer would hold blended data representing visible fragments “F” and “C,” and the fragment buffer would still hold two fragments, “E” and “D.”

At the point where a complete cycle has been made through the fragment buffer, the fragment logic then toggles or “switches” Z-value storages. That is to say, the Z-value storage associated with the first frame buffer is used to sort the distance for the next-to-furthest fragment, and the Z-value storage of the second frame buffer now identifies the furthest visible fragments remaining in the fragment buffer. Processing (including error processing 121) then continues in the manner described above except that the second frame buffer is used for comparison to identify and remove fragments from the fragment buffer while the first frame buffer is used to calculate the Z-value of the next furthest fragment for pixel locations still having fragments for the next round. Block 119 shows the Z-buffers' interpretation as “B′_{NZ}” and “B_{NZ}” are toggled. Because each cycle of phase three alternates slightly, cycles relying upon the Z-value storage of the first frame buffer to remove fragments from the fragment buffer are referred to as “even” phases, whereas cycles relying upon the Z-value storage of the second frame buffer for this purpose are referred to as “odd” phases of processing.

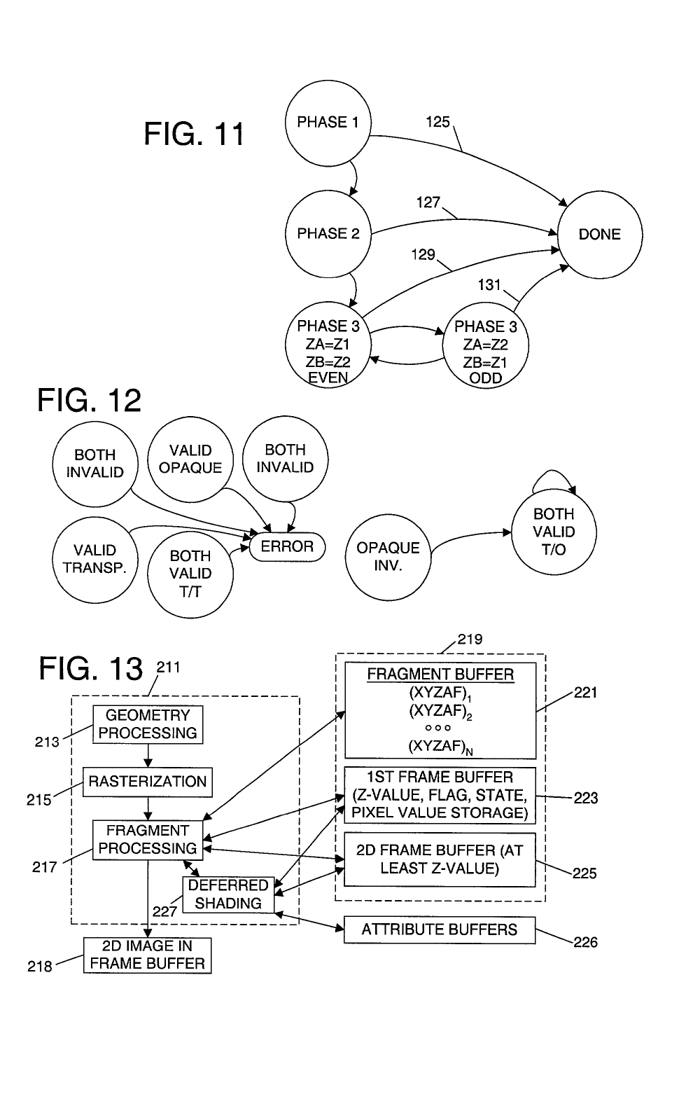

FIG. 11 is a diagram that shows transition between phases, and provides some indication of the switching between odd and even phases in phase three. In particular, as indicated by four arrows 125, 127, 129 and 131, if the fragment buffer is empty at or following the end of a phase, processing is finished. If processing continues through to phase three, the primary Z-value storage (labeled “ZA” in FIG. 11) is effectively linked to the Z-value storage of the first frame buffer, and the secondary Z-value storage (labeled “ZB” in FIG. 11) is linked to the Z-value storage of the second frame buffer. As indicated in the paragraph above, with each cycle through the fragment buffer, this linking is switched, such that the Z-value storage of the second frame buffer becomes the primary Z-value storage during even phases. Switching between odd and even phases continues with each cycle through the fragment buffer, until the fragment buffer is empty.

FIG. 12 shows general state transition information for processing during phase three. In particular, a pixel location should not be accessed unless there is a corresponding fragment on the fragment buffer to trigger such access. Accordingly, if the system sees any of states “BOTH_INVALID”, “VALID_OPAQUE”, “BOTH_VALID T/T” or “VALID_TRANSPARENT,” error processing will be initiated. As mentioned earlier, any state of “OPAQUE_INVALIDATE” discovered during an attempt to match a fragment will be cleared and will become “BOTH VALID T/O.” [In some systems, it may be desired to compare the Z-value of the fragment from the fragment buffer with the corresponding Z-value storage and detect an error if the new fragment has greater depth, but in the preferred system, it is presumed that this error will not occur. As mentioned earlier, errors in the preferred embodiment can be ignored if limited to a single or small number of pixels, whereas a sufficient number of aggregate errors can be used to trigger an application halt, or to report significant hardware failure to the user.] Table III, below, provides specific state and transition information for phase three processing.

TABLE III
PHASE THREE STATE AND STATE TRANSITION INFO.

| | | | NEW |
|---|---|---|---|
| CURRENT STATE | INPUTS | OUTPUTS | STATE |
| OPAQUE_INV. | F_{Z} = B_{NZ} | COMPOSITE, | BOTH_{—} |
| | | B_{Z} = B_{NZ} OR B′_{NZ} = B_{NZ} | VAL._T/O |
| OPAQUE_INV. | F_{Z} ≠ B_{NZ} | B_{Z} = F_{Z} OR B′_{NZ} = F_{Z}, | BOTH_{—} |
| | | QUEUE F | VAL._T/O |

(BOTH_VAL._T/O provides same behavior as BOTH_VAL._T/O of phase two)

[In Table III, above, the designation F refers to the fragment from the fragment buffer, the designation B refers to the contents of the frame buffer, the subscript designation Z refers to associated Z-value, the subscript designation NZ refers to the contents of the Z-value storage used for purposes of compositing, and the the designation B′_{NZ} refers to the contents of the Z-value storage used for purposes of isolating the next furthest fragment that will be the furthest remaining fragment in the next phase of processing.]

As can be seen from this description, the present invention enables special hardware (including a fragment buffer, a pixel value storage or frame buffer, and at least one Z-value storage) to effectively sort fragments via hardware and blend those fragments as appropriate to provide for correct transparency effects. As discussed earlier, conventional wisdom (such as using typical Z-buffer architecture) would be to combine fragments in any order received, discarding only obscured fragments. As indicated earlier with respect to the swimming pool hypothetical, this type of operation can lead to transparency errors. Furthermore, other conventional approaches (such as represented by A buffer or antialiasing approaches) would typically be implemented in software and would typically require many more iterations in order to provide transparency effects. The preferred embodiment described above permits proper transparency computation to be done exclusively or primarily in hardware and to this effect, it implements most of the functions just described in hardware, leaving software (e.g., firmware or software) to primarily manage the exchange of fragments between rasterization and the fragment logic. Some or all of the hardware control functions just described could be implemented in software if desired.

III. Application Of The Preferred Hardware To Deferred Shading Applications

FIG. 13 is used to illustrate use of the preferred hardware in a deferred shading system. In particular, deferred shading can be implemented as both front-to-back or back-to-front processing, as part of a pipeline architecture. Other special effects, such as texturizing and the like, can also be implemented using similar methodology. In FIG. 13, a block 227 labeled “deferred shading” will be used to represent all special effects processing, e.g., lighting, shading, texturing and other graphics effects. Deferred shading will be described in the context of front-to-back processing in the description that follows.

As indicated in FIG. 13, processing in a typical application occurs in a manner much like the processing described above for simple back-to-front processing. Process steps, seen at a left side 211 of FIG. 13, generally perform geometry process and rasterization steps 213 and 215 as described earlier. Similarly, fragment processing 217 is employed using the same hardware mentioned earlier and seen in a dashed line box 219 at a right side of FIG. 13. This hardware includes a fragment buffer 221, a first frame buffer 223 and a second frame buffer 225.

Unlike the embodiment described above, the frame buffers 223 and 225 are more extensively used in connection with deferred shading processing. For example, as indicated by FIG. 13, each frame buffer includes storage space for pixel values, Z-values, state information as well as a flag (the purpose of which will be explained further below). The preferred embodiment also relies upon one or more attribute buffers 226 (as might be conventionally used in deferred effects applications). The attribute buffers will typically contain information on shading, texturing or other effects to be applied. For example, the attribute buffers might specify attenuation of light dependent upon X, Y (pixel location) or Z (depth), or texturing effects that similarly vary in a linear or other manner.

As would be the case for the embodiment described above, phase one proceeds to find the closest opaque fragment or furthest visible transparent fragment for each pixel location. Similarly, phase two processing is used to cull obscured fragments as well as to identify a next furthest fragment (which necessarily is transparent). At this point, deferred effects processing may be performed as part of a pipeline process (intermediate to the fragment ordering and compositing process) since all obscured fragments will have been culled during the first two phases of processing and only visible fragments (e.g., fragments contributing to the visible image) will remain. In the preferred deferred effects system, shading, texturing and other effects can directly be applied on fragments at this stage of processing; once complete, fragment compositing can be reinitiated as has been previously described.

In one contemplated deferred shading application, deferred effects could occur in parallel with composition, with two or more frame buffers being loaded with fragments and with deferred effects and composition being effected almost simultaneously. In this embodiment, a register or flag can be associated with each fragment. [FIG. 13 indicates the possible use of such an embodiment via use of the word “flag” at the right side of FIG. 13.] Deferred effects may be performed upon any fragments in the frame or fragment buffers after phase one, with composition of two fragments allowed to proceed only if an associated bit is set (indication completion of deferred effects processing) for each fragment. In yet another possible embodiment, deferred effects could be performed as a subroutine that is called each time a “next” fragment is located for composition into the frame buffer. These deferred effects methodologies as well as conventional deferred effects algorithms may be readily accomodated by the preferred hardware.

Irrespective of deferred effects methodology, the final result of processing, once fragment processing and deferred effects have been completed, will be a 2D image ready for display as indicated by block 218 of FIG. 13. Importantly, by deferring effects processing until the end of phase two (or the end of phase one if there are no overlapping fragments for a given image), the embodiment just described shades only visible fragments, and avoids devoting resources to shading, texturing and other special effects that will only be culled by subsequent processing. The embodiment just described permits back-to-front processing, with true transparency and deferred shading, via a principally-hardware implementation, and it avoids wasting resources on shading data that will ultimately be discarded.

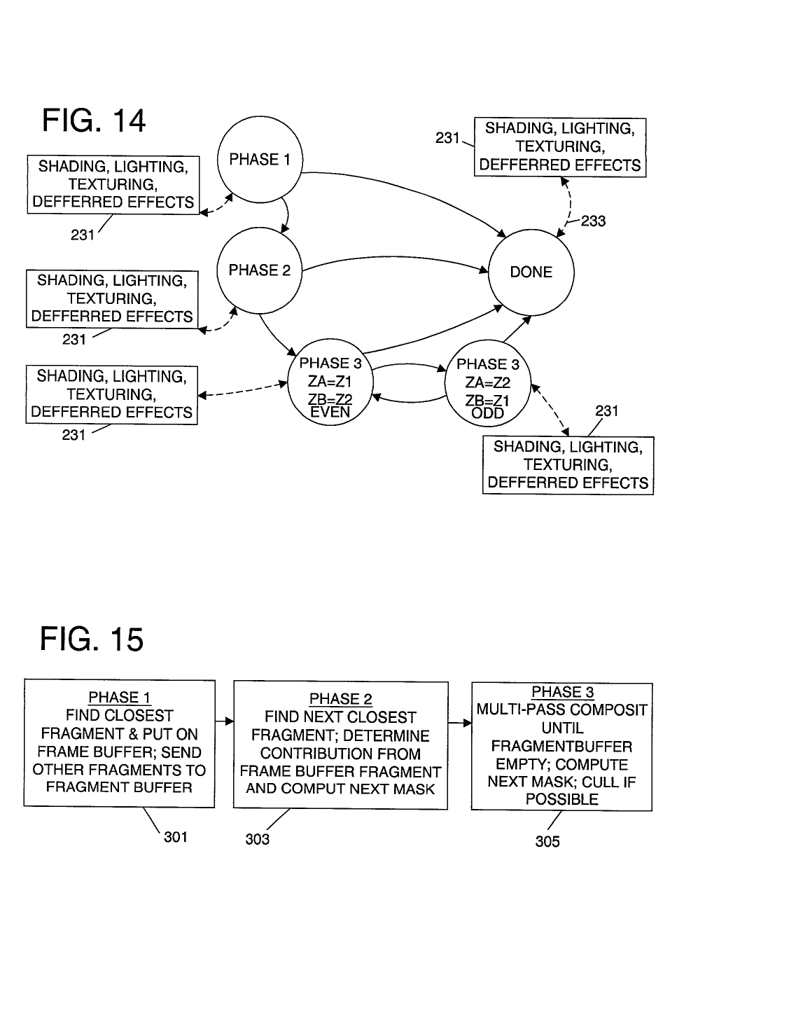

FIG. 14 provides a phase transition diagram, similar to FIG. 11, that elaborates upon processing in the deferred shading application just described. In particular, the flow between phase one, phase two and phases three-even and three-odd are as has been described earlier; however, deferred shading, indicated in FIG. 14 by dashed line reference numeral 231, preferably occurs in parallel with processing in any phase of processing, and even once the fragment processing has finished as indicated by reference arrow 233.

Importantly, as was indicated earlier, a preferred hardware solution supports any of back-to-front, front-to-back, and deferred effects processing as may be desired by a user. To this effect, preferred hardware for these different applications, collectively indicated by reference numeral 19 of FIG. 1 and reference numeral 219 of FIG. 13, is one and the same design, including a fragment buffer and at least two frame buffers, each of which includes an extra bit of storage as indicated above in connection with deferred effects processing.

IV. Use Of The Preferred Hardware In Antialiasing Some Front-To-Back Processing Applications

Antialiasing applications and some front-to-back processing applications (where partial pixel opacity is an issue) must be handled differently than described above, because in these systems it is sometimes possible to have intersecting surfaces or partial coverage within a given pixel. To perform antialiasing, masks are conventionally computed at the time that a primitive (e.g., polygon) is rasterized to create fragments; the masks define a sub-pixel sampling of each fragment to provide information on those portions of a given pixel that are occupied by the fragment. One well known antialiasing method is described in “The A-Buffer, an Antialiased Hidden Surface Method” by Loren Carpenter, Computer Graphics, Volume 18, Number 3, July 1984, which is hereby incorporated by reference.

In antialiasing approaches, fragments are typically described as either blocking an entire pixel or having a boundary which falls upon a pixel. Typically, a mask is computed at the rasterization step to describe how much of the pixel is covered by the fragment, such as a 4×8 bit array or similar size array that represents sub-pixel coverage, as is described by the Carpenter paper referenced above.

Antialiasing methodology similar to that described by Carpenter can be applied to the preferred hardware to effectively blend fragments in order from closest-to-furthest without involving the time needed to do a full software fragment sort as would be conventional. To this effect, the preferred hardware is controlled to effect front-to-back blending in three phases, illustrated in FIG. 15. Fragments from a rasterization step (not seen in FIG. 15) will typically be accompanied by fragment coverage masks to represent the extent of pixel coverage by a given fragment.

In a first phase of processing, 301, the system stores fragments and performs culling if it determines that a received fragment is completely obscured; a closest fragment is identified and stored in a frame buffer, and all other fragments are queued into the fragment buffer. The system calculates color contribution from the first, frame buffer fragment and calculates a coverage mask and a search mask to be applied to data lying behind the first fragment, and stores this data back into the frame buffer. In the second phase of processing 303, the system passes through the fragment buffer and uses a first Z-value storage to retrieve and composite the closest fragment of the fragment buffer with frame buffer contents or (if appropriate) culls any completely obscured fragments from the fragment buffer. The system, as was the case with the preferred embodiment, simultaneous uses a Z-value storage to identify the next-closest fragment in the fragment buffer for processing during phase three. Finally, in phase three 305, the system identifies and composites into the frame buffer in “odd” and “even” phases the fragments remaining on the fragment buffer, one at a time, in order of closest fragment. During each composition (or blending), the system calculates two masks (an aggregate coverage mask and a search mask) that will be used in processing the next subsequent fragment as well as an transparency weighting used to scale color contribution from the next fragment; the system also searches for the closest depth value while the next-closest Z value is found using the second Z-value storage. Coverage masks stored back into the frame buffer together with the associated fragment.

Importantly, in the embodiment described below, it is assumed that there is effectively one frame buffer, two Z-value storages (one belonging to the frame buffer), and one fragment buffer; this hardware exactly matches the hardware described earlier (where two frame buffers are effectively used as one full frame buffer plus an extra Z-value storage). In embodiments where there are extra frame buffers available (e.g., three frame buffers each having a Z-value storage, used as two frame buffers plus one extra Z-value storage), several fragments can be taken from the fragment buffer and composited at once into the frame buffer.

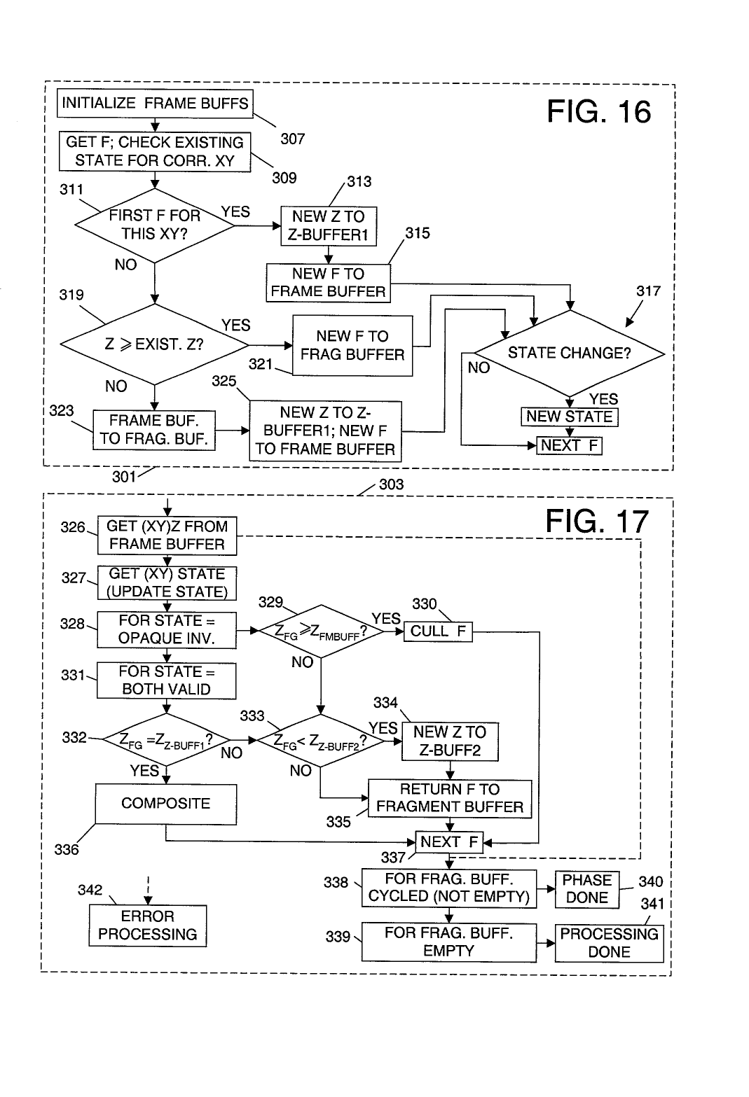

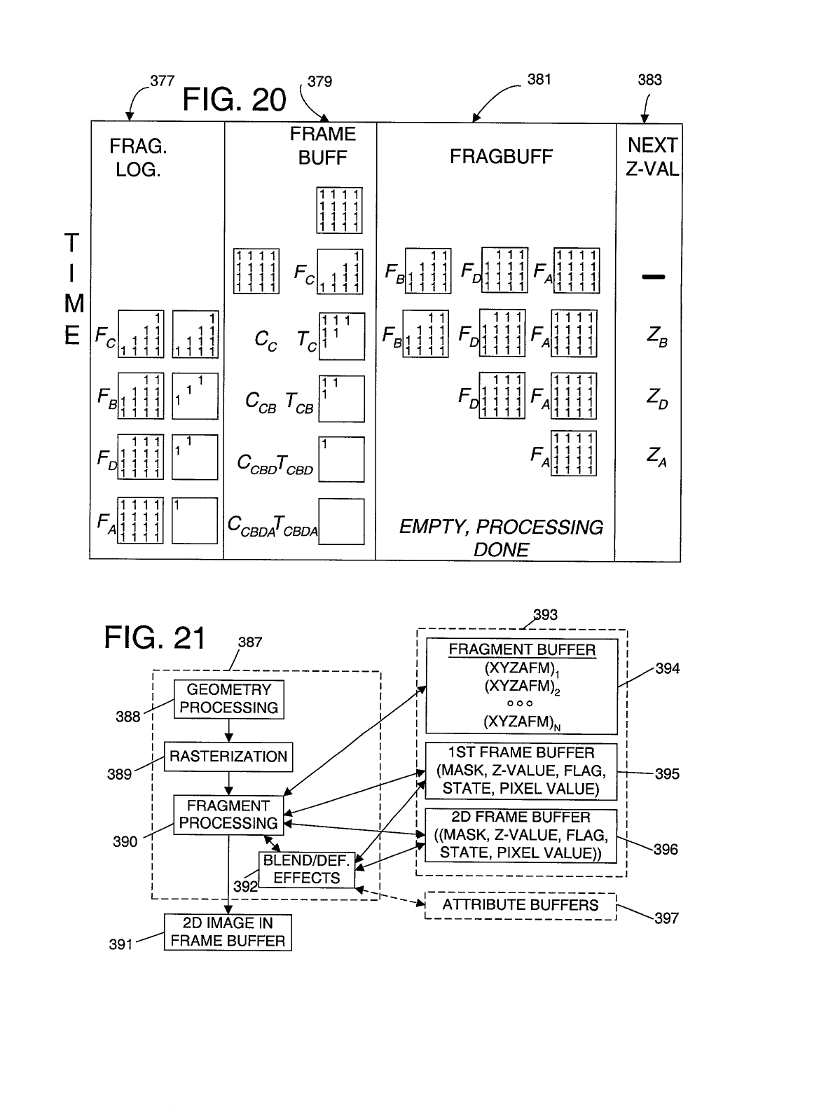

FIGS. 15-21 will be used to explain application of an antialiasing strategy to the preferred hardware. In particular, FIGS. 16-18 respectively indicate processing during the three phases of FIG. 15. FIG. 19 provides a hypothetical set of four surfaces that are to be combined into a single blended fragment. FIG. 20 is a diagram used to explain the calculation of masks and blending together of the four hypothetical surfaces of FIG. 19. Finally, FIG. 21 illustrates a pipelined hardware approach to antialiasing.

FIG. 16 provides detail on the first phase of processing. In particular, the system first initializes the frame buffers that will be used to perform fragment processing, as indicated by block 307. As with the processing described earlier, the system upon receiving a new fragment checks state information for the corresponding X, Y pixel location to determine whether any fragments exist in the frame buffer, as represented by block 309. Importantly, the same states as described above, “BOTH_INVALID,” “VALID_TRANSPARENT,” “VALID_OPAQUE,” “BOTH_INVALID,” “BOTH_VALID T/O” and “BOTH_VALID T/T” are still used by the preferred hardware, although these states will be generated in a slightly different manner. If a new fragment is indeed the first fragment for a given pixel, then the fragment is immediately stored in the frame buffer and the state updated, all as indicated by blocks 311, 313, 315 and 317 of FIG. 16.

If a fragment already exists in the pixel value storage portion of the frame buffer which corresponds to a newly-received fragment, then the system queries whether the Z-value of the newly-received fragment is greater than or equal to the fragment already in the frame buffer. In this embodiment, if two fragments have the same Z-value, the earlier fragment is presumed to lie in front of the later-received fragment. The relatively-closer fragment is stored (or kept) in the frame buffer, whereas the relatively-farther fragment from a desired viewpoint is queued into the fragment buffer. This processing is indicated by blocks 319, 321, 323 and 325 of FIG. 16. Processing continues until all fragments have been received from the rasterization step, at which time a register or control is set (as described above in connection with back-to-front processing) that causes fragment logic to begin phase two processing.

Phase two processing 303 is depicted in FIG. 17. In particular, phase two calls for the system to pass through the fragment buffer in a manner roughly analogous to the process used in back-to-front fragment processing; during this phase, the system loads the Z-value storage with a Z-value corresponding to the next closest fragment. These processes and error processing are indicated by process blocks 326-342 of FIG. 17. Importantly, the system either through interrupt processing or a software test monitors the fragment buffer throughout phase two (as well as phase three) to determine when processing has finished, as represented by an empty fragment buffer. This processing is indicated by reference numerals 339 and 341 of FIG. 17.

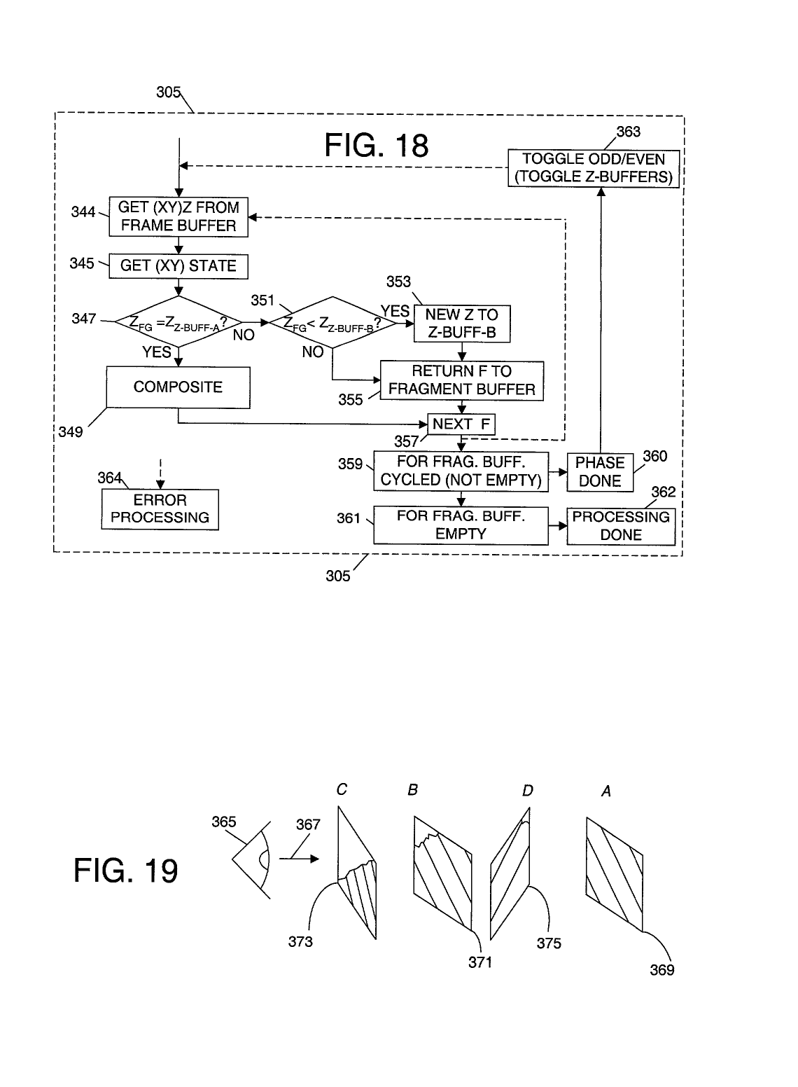

In phase three 305 (indicated by FIG. 18), the system proceeds to cycle through the fragment buffer to remove the next closest fragment and blend it into the frame buffer. It uses the primary Z-value storage to make this extraction, while it simultaneously uses the secondary Z-value storage to sort Z-values to determine the next closest fragment left in the fragment buffer. This processing is indicated by blocks 344-345, 347, 349, 351, 353, 354, 355 and 357. As was the case with the embodiments discussed earlier, the system continually monitors memory control registers for the fragment buffer to detect when the buffer is empty, as represented by blocks 361-362; processing is finished when the fragment buffer is empty. After each cycle through the fragment buffer as indicated by blocks 359-360 and 363, the system toggles phases and Z-buffer usage as has been previously described in connection with back-to-front processing. Error processing is as has been previously described and is represented in FIG. 18 using reference numeral 364.

FIG. 19 is used to explain an example of fragment blending in application of an A-buffer or antialiasing methodology. In particular, each fragment is accompanied by a mask, typically a 4×8 bit mask, that describes sub-pixel coverage by a fragment. FIG. 19 shows a human eye depiction 365, a viewing perspective represented by an arrow 367, and four surfaces 369, 371, 373 and 375 that are to be blended. It is to be assumed that a fragment representing each of the four surfaces arrives in the order indicated by alphanumeric lettering in FIG. 19, respectively, in the order of fragment “A,” followed by fragment “B,” followed by fragment “C,” and finally by fragment “D.” The preferred hardware will effect ordered blending/removal from the fragment buffer in order or relative proximity from the desired viewpoint, represented by the human eye depiction 365 in FIG. 19. Notably, each surface, 369, 371, 373 and 375 has a different orientation, and is depicted via hatching as covering part or all of a pixel of interest. The varied three-dimensional orientation depicted in FIG. 19 signifies that primitives may be handled by the preferred hardware, including situations where surfaces are represented via complex slope patterns.

FIG. 20 is an illustration used to explain the blending of the multiple fragments indicated in FIG. 19. In particular, FIG. 20 shows four columns 377, 379, 381 and 383 that indicate, respectively, the contents or processing operand of the fragment logic, the frame buffer, the fragment buffer and the extra (or secondary) Z-value storage. The various rows of entries in FIG. 20 represent from top-to-bottom, (a) initialization, (b) end of phase one, (c) beginning of phase two processing, where the frame buffer contents are processed to incorporate any transparency effects, (d) end of phase two processing (first composition representing surfaces “B” and “C”), (e) end of phase three first iteration (composition representing surfaces “B”, “C” and “D”), and (f) finished blending of all four surfaces.

Prior to any processing for the current frame, the frame buffer is initialized to have an initial covereage mask for each pixel, where each coverage mask has all “ones” for each entry (thereby indicating that nothing is obscured). These entries are collectively indicated by a top row of FIG. 20.

When phase one has completed, the closest fragment “C” together with its coverage mask will be stored in the frame buffer, whereas fragments “B,” “D,” and “A” will be stored in the fragment buffer together with their coverage masks. This event is indicated by the second row of FIG. 20, where it will be seen that the frame buffer (i.e., the second column of FIG. 20) shows the prior, initial coverage mask (i.e., the mask of all “ones”) stored with a fragment for the surface “C” and a coverage mask for that fragment.

Fragment processing then proceeds according to the methodology desired, e.g., front-to-back processing. Importantly, 4×4 bit matrices are used in FIG. 20 for ease of explanation, in lieu of the 4×8 matrices referenced earlier; each of these matrices will have been computed during the rasterization phase and delivered together with each fragment and will be preferably stored during fragment processing together with the associated fragment.

In phase two processing, the fragment logic uses aggregate coverage of closer objects and coverage for the current fragment (in the frame buffer for the initial composition only) to (a) calculate a “delta” mask for use in weighting color contribution for the current fragment, (b) calculate and store in the frame buffer an aggregate color contribution based upon this “delta” mask, (c) calculate and store in the frame buffer an aggregate transparency weight for blending future fragments, and (d) calculate and store in the frame buffer a search mask to find unobstructed representations of further objects in subsequent cycles through the fragment buffer. These computations are respectively depicted in the FIG. 20, ordered into a first column 377 (representing fragment logic operands) and a second column 379 (representing fragment logic outputs stored in the frame buffer). As indicated by FIG. 20, the frame buffer at the end of each composition will include a color value “C_{C},” the transparency weight “T_{C},” and a search mask (or “mask out”), the latter two for use in the next composition. Also during phase two, the system cycles through the fragment buffer as has been previously described to detect the Z-value of the next-closest fragment “B;” the system stores this value in the Z-value storage (indicated via the right-most column 383).

The value “C_{C}” indicated above and in FIG. 20 represents color contribution for the current fragment, and is calculated by multiplying the color of the current fragment by its “delta” mask and by any previously computed transparency weight. The “delta” mask is calculated by taking the coverage mask for the current fragment and its intersection with the prior search mask. In this example, as indicated by FIG. 20, the delta mask is computed by taking the prior search mask (initialized to be all ones in the case of the closest fragment) with the coverage mask for fragment “C.” Based on this value, the fact that transparency for the first fragment is taken to be one, and the fact that the coverage mask for fragment C has 10 “ones” out of a maximum of 16 bits, color contribution for fragment “C” would be the color of that fragment scaled by ⅝. The transparency weight T for the next phase is calculated to be the products of “1” minus each prior fragments' coverage, in this case (1⅝), or (⅜). These aggregate color, the transparency weight and the search mask for the next phase are stored back into the frame buffer.

During phase three, the fragment logic uses the contents of one (primary) Z-value storage to isolate and remove the closest remaining fragment for the pixel under consideration from the fragment buffer, while it uses another (secondary) Z-value storage to calculate the depth of the next fragment. In “odd” and “even” phases, the system continues toggling Z-value storages as has been described earlier, such that one fragment can be removed and processed with each cycle through the fragment buffer. Each fragment as it is removed is blended with contents of the frame buffer as has been described just above; that is to say, a color contribution for the current fragment (fragment “B”) is calculated and blended together with existing frame buffer contents. Simultaneously, a new transparency weight and search mask are computed for use in a subsequent cycle through the fragment buffer. This operation is indicated in the fourth row of FIG. 20, which shows fragment “B” as being the operand of the fragment buffer, and a blended color “C_{CB}”=“C_{B}”+“C_{C}.” The aggregate color for surfaces “B” and “C” is computed in the same manner mentioned above, i.e., equal to the color from the previous composition plus the color of fragment “B” times its delta of coverage (3/16) times a transparency weight for prior fragments T_{C} (⅜), or “C_{B}” times (⅜) (3/16). The transparency weight for the next subsequent cycle is also calculated, and is the product of factors equal to “one” minus each prior coverage, or 1 times (1⅝) times (1 13/16). Finally, the search mask for the next phase is the un-occluded search area for prior phases. Each of these computations is respectively indicated in the fourth row of the second column 379 of FIG. 20.

Notably, at the end of each “odd” or “even” phase, a blended color will be left in the frame buffer and the Z-value of the next closest fragment remaining in the fragment buffer will be located in the secondary Z-value storage, ready for the next cycle of processing. As indicated by the third column 381 of FIG. 20, with each cycle, one fragment is removed from the fragment buffer, and processing in this manner continues until the fragment buffer is empty. At the completion of processing, a blended color, transparency weight and new search mask will be left in the pertinent pixel value storage (i.e., in the primary frame buffer).

FIG. 21 shows hardware used to perform pipelined antialiasing methodology. In particular, a left side 387 of FIG. 21 shows geometry processing 388, rasterization 389 and fragment processing steps 390 as was the case with prior embodiments, all performed to develop a final 2D image 391. As with the case with deferred effects processing, a separate composition stage 392 may be performed for blending and deferred effects. To this effect, as was the case for deferred effects processing, the hardware 393 preferably includes a fragment buffer 394, and at least two frame buffers 395 and 396; notably, each of these storage elements includes space associated with each pixel for storage of a mask, a Z-value, state information and a flag. The flag is used in the same manner described above in connection with deferred effects processing; that is, to say, the system uses the pixel storage of the first frame buffer 395 as primary storage, and a next closest unblended fragment may be stored in the second frame buffer 396 at the appropriate pixel location. Blending effects can in this manner be performed by a separate stage of the pipeline (e.g., represented by block 392). If desired, deferred effects can also be implemented by this separate stage as indicated by the presence in FIG. 21 of optional attribute buffers 397.

It should be apparent that many minor variations may be effected to the embodiments described above to build devices or methods that implement the principles of the present invention. For example, it is possible to build a system that operates on a pixel-by-pixel basis, e.g., that analyzes each pixel location (or state information) in succession as the basis for processing instead of simply detecting whether there are contents remaining in the fragment buffer. Alternatively, it is possible to build a system using principles of the present invention that does not use a FIFO memory as the fragment buffer, or that does not remove fragments as they are composited but simply invalidates (or otherwise inhibits use of) those fragments using a flag or some other mechanism. Finally, it is also possible to construct a front-to-back processing system that operates in the inverse manner of a back-to-front system, that is, without using sub-pixel masks as was described above in connection with antialiasing.

Having thus described several exemplary implementations of the invention, it will be apparent that various alterations, modifications, and improvements will readily occur to those skilled in the art. Such alterations, modifications, and improvements, though not expressly described above, are nonetheless intended and implied to be within the spirit and scope of the invention. Accordingly, the foregoing discussion is intended to be illustrative only; the invention is limited and defined only by the following claims and equivalents thereto.

1. A device adapted to receive multiple fragments representing overlapping data for a pixel location and output at most one blended pixel, comprising:
a first storage;
a fragment buffer that holds multiple fragments for overlapping data; and
one of instructions and hardware that causes said device to
detect in the fragment buffer a fragment representing predetermined one of closest and furthest visible data for the pixel location,
blend the predetermined one with any preexisting contents of the first storage that represent data that is to be visible in an output image, and
repeat the detecting and blending until no more unprocessed fragments representing visible image data are left in the fragment buffer for the pixel location;
wherein detection of the predetermined one is performed using a Z-value storage to isolate during a first pass through the fragment buffer a Z-value corresponding to the predetermined one, and to match during a second pass through the fragment buffer contents of the Z-value storage against fragment buffer contents to isolate the predetermined one.

2. A device according to claim 1, wherein said device composites back-to-front and further comprises one of instructions and hardware that processes contents of the fragment buffer by:
first, detecting any fragment representing a closest opaque data, moving such fragment to the first storage to overwrite any prior contents and removing such fragment from further consideration as fragment buffer contents;
second, examining depth of fragments in the fragment buffer relative to any closest opaque data and removing from further consideration any fragments obscured by closest opaque data; and
third, compositing any fragments for the pixel location remaining in the fragment buffer with contents of the pixel value storage in back-to-front order.

3. A device according to claim 1, wherein each fragment for the pixel location further has associated with it a sub-pixel mask and wherein said device further comprises one of instructions stored and hardware associated with the device that implements antialiasing using the sub-pixel mask to blend visual contributions by each fragment representing visible data in dependence upon the associated mask.

4. A device according to claim 1, wherein:
the fragment buffer stores fragments that collectively representing multiple pixel locations;
the pixel value storage is part of a frame buffer, the frame buffer having at least one first storage location for each pixel within an image region; and
said device further comprises one of instructions and hardware that composites data by successively examining fragments in the fragment buffer and by combining those fragments into the frame buffer as the predetermined one for the corresponding pixel location or returning them to the fragment buffer if they are not the predetermined one, and by repeating the combining or returning until the fragment buffer is completely empty.

5. A device according to claim 4, wherein said device composites back-to-front and processes each pixel location by:
first, detecting any fragment representing a closest opaque object, moving such fragment to the first storage and removing such fragment from further consideration as fragment buffer contents;
second, examining depth of fragments in the fragment buffer relative to any closest opaque image object and removing from further consideration any fragments representing data obscured by a closest opaque object; and
third, compositing any fragments remaining in the fragment buffer corresponding to the particular pixel location with contents of the first storage in back-to-front order.

6. A device according to claim 5, wherein said the fragment buffer is a first-in, first out memory and wherein said device examines successive fragments in the fragment buffer and either composites those fragments if they represent furthest visible data for a pixel location, or returns those fragments to the fragment buffer if they do not represent furthest visible data for a pixel location, and performs the compositing or returning until the fragment buffer is completely empty.

7. A device according to claim 1, wherein said device further comprises a state generation unit that produces state information to indicate at least:
a state that there is a fragment for to the pixel location representing relatively closer opaque data than other fragments in the fragment buffer which have not yet been invalidated; and
a state that there are at least two fragments each representing visible data for a corresponding pixel location.

8. A device according to claim 7, wherein:
the first storage is part of a frame buffer having a unique address space for each pixel location, the unique address space for each pixel location adapted to store color and intensity information as well as state information for the pixel location.

9. A device according to claim 1, wherein:
the Z-value storage and the pixel value buffer are part of a frame buffer;
said device further comprises a second Z-value storage; and
the Z-value storage of the frame buffer and the second Z-value storage are used in alternating fashion in a manner where one Z-value storage holds a Z-value for fragment representing a predetermined one of closest and furthest visible data for a particular pixel location that will be moved and removed from the fragment buffer during a current pass through the fragment buffer, while the other Z-value storage is used to sort Z-values for other fragments for the particular pixel location that will be moved and removed during a subsequent pass through the fragment buffer.

10. A device according to claim 1, wherein said device composites front-to-back and further includes one of instructions and hardware that causes said device to process fragment buffer contents by:
detecting a fragment representing transparent data for a pixel location;
storing a depth value of a detected fragment in a Z-value storage if the depth value for the fragment indicates data for the fragment is relative closer to the desired viewing perspective than data for previously detected fragments;
using the stored depth value to identify the fragment representing closest remaining visible data for the pixel location, compositing the fragment with contents of the pixel value storage for that particular pixel location, and
inhibiting further consideration of such detected fragment from further consideration as fragment buffer contents; and
repeating the processing of contents of the fragment buffer until no more fragments are left for consideration in the fragment buffer for the particular pixel location.

11. A method of arbitrating multiple fragments representing overlapping data for a pixel location and outputting at most one representation for that pixel location, using a pixel value storage, a fragment buffer, and hardware logic, said method comprising:
storing in the fragment buffer multiple fragments representing data overlapping in at least one pixel location;
using the hardware logic to index, detect and remove from the fragment buffer a fragment representing a predetermined one of closest and furthest visible image data at the pixel location;
combining that predetermined one with any preexisting pixel value storage contents that represents visible data; and
repeating the using and combining until no more fragments are left in the fragment buffer that correspond to the pixel location.

12. A method according to claim 11, further comprising fragments back-to-front by:
first, detecting any fragment representing closest opaque data, moving such fragment to the pixel value storage to overwrite any prior contents and removing such fragment from further consideration as fragment buffer contents;
second, examining depth of fragments in the fragment buffer relative to any closest opaque image data and removing from further consideration any fragments that are obscured by closest opaque data; and
third, compositing any fragments remaining in the fragment buffer with contents of the pixel value storage in back-to-front order.

13. A method according to claim 11, wherein each fragment for the pixel location further has associated with it a sub-pixel mask and wherein said method further comprises performing antialiasing using the sub-pixel mask to blend visual contributions by each fragment for the pixel location in a manner responsive to values of each mask.

14. A method according to claim 11, further comprising:
generating state information indicating at least
a state that there is opaque data for the pixel location relatively closer than other data represented by fragment buffer fragments which have not yet been invalidated, and
a state that there are at least two fragments representing visible data for the pixel location; and
using the state information for the pixel location to process fragments in a manner dependent upon the state information.

15. A method according to claim 11, further comprising compositing fragments front-to-back by:
detecting a fragment representing transparent data for a pixel location;
storing a depth value associated with a detected fragment in a Z-value storage if the depth value indicates that data for the detected fragment is relatively closer to the desired viewing perspective than data for previously detected fragments;
using the stored depth value to determine the closest transparent data at the particular pixel location, compositing the fragment representing closest transparent data with contents of the pixel value storage for that pixel location, and inhibiting further consideration of such detected fragment from further consideration as fragment buffer contents; and
repeating the processing of contents of the fragment buffer until no more fragments are left for consideration in the fragment buffer for the particular pixel location.

16. A method according to claim 15, wherein the repeating is performed on a fragment-by-fragment basis for fragments in the fragment buffer, with fragments not constituting the predetermined one being returned to the fragment buffer in first-in, first out format, until no more fragments are left in the fragment buffer.

17. In a data processing system where multiple fragments representing overlapping data for a three-dimensional environment are arbitrated to determine a single image value for storage in a particular pixel location of a frame buffer, an improvement comprising:
first, identifying and storing a first fragment in a first buffer, with remaining fragments representing overlapping visible data being stored in a second buffer, where the first fragment represents a predetermined one of closest and furthest visible data from a desired viewing perspective;
second, generating an index that permits retreival of the first fragment with respect to fragments in the second buffer for the particular pixel location, and storing the index in a third buffer; and
third, using the contents of the third buffer to identify and remove a fragment from the second buffer in dependence upon depth, and blending the removed fragment with contents of the first buffer.

18. An improvement according to claim 17, wherein:
the first buffer is part of a frame buffer and the frame buffer includes a pixel value storage unique to the particular pixel location;
the second buffer is a fragment buffer that collectively holds fragments for multiple pixel locations; and
the third buffer is a Z-value storage corresponding to the particular pixel location.

19. In an image processing system where multiple fragments representing overlapping data are arbitrated to determine a single value representing a particular pixel location of a viewing image, an improvement comprising:
placing multiple fragments into a fragment buffer;
polling fragment buffer contents to identify a predetermined one of maximum and minimum Z-value for fragments for the particular pixel location;
moving the identified fragment to a frame buffer, combining that fragment with any preexisting contents that are to be visible in an output image, and removing the identified fragment from further consideration as fragment buffer contents; and
repeating the polling and moving until no further fragments are left for the particular pixel location.

20. An improvement according to claim 19, further comprising:
storing fragments corresponding to many pixel locations, all collectively in the fragment buffer;
returning fragments not corresponding to the predetermined one into fragment buffer for later-consideration as a predetermined one; and
performing the repeating until no fragments are left in the fragment buffer.

21. An improvement according to claim 19, further comprising:
compositing fragments for overlapping visible data in back-to-front manner, by
first, polling the fragment buffer to identify any fragment representing closest opaque data for the particular pixel location and moving such fragment to a frame buffer,
second, culling fragments obscured by the closest opaque data, and
third, identifying and compositing with contents of the frame buffer each fragment remaining in the fragment buffer representing furthest data for the particular pixel location.

22. A data processing system that blends multiple fragments each representing visible imagery from a viewing perspective, comprising:
means for identifying and storing any fragment representing closest opaque data or furthest transparent fragment if there is no closest opaque data; and
means for successively detecting and blending with the stored fragment in order of greatest depth each remaining fragment representing furthest unprocessed unobscured visible data.
